(19) United States
(12) Patent Application Publication
(10) Pub. No.: US 2010/0222014 A1
(43) Pub. Date: Sep. 2, 2010

(54) RF Switch Device

(76) Inventor: Niklas Philipsson, Knivsta (SE)

Correspondence Address: COATS & BENNETT, PLLC, 1400 Crescent Green, Suite 300, Cary, NC, 27518, US

(21) Appl. No.: 12/664,338

(22) PCT Filed: Sep. 13, 2007
(86) PCT No.: PCT/SE2007/000804

§ 371 Date: Dec. 11, 2009

(30) Foreign Application Priority Data
Jun. 18, 2007 (SE) 0701530-8

(51) Int. Cl. H04B 1/02

(52) U.S. Cl. 455/91

(57) ABSTRACT

In a device (11) for switching RF-signals in a radio unit (DRU) there is provided an RF matched card holder (12) for mounting on a printed circuit board (PCB) of the radio unit, said card holder having multiple signal coupling contact elements (15) supported therein; an RF matched switch card (13) to be received in alternative positions in the card holder; multiple sets of contact pads (16 and 17, respectively) on at least one side (13 A, 13B) of the switch card; and signal paths (SP) extended between selected contact pads of each set.

### TECHNICAL FIELD

The present invention relates to radio units for transmitting and receiving radio signals.

### BACKGROUND

Switches are commonly used in electronic appliances for routing RF signals. For such switches, it has in the past been well known to use relay type electromechanical switches. Such prior art electromechanical type switches have been very successfully used in many applications where radio signals should be coupled in different directions. They have primarily been considered to benefit from being reliable and well suited for high power RF applications and for use in higher frequency ranges. They are therefore still used in several applications within the field of telecommunications; in spite of their relatively high production cost as well as comparatively large space requirement. Quality problems have also been frequent, leading to extensive time consumption for handling and replacing these relays and to considerably added cost.

In related communication areas it has been common to use semiconductor type elements, such as with transistors or diodes, for the RF switches. Such switches do not present optimal switching characteristics and are normally not selected for high-power applications. Specifically, their use in higher frequency applications is questionable on account of the fact that they present high loss across the switch when closed and signal leakage when open. There are also isolation issues appearing in applications of semiconductor type switches, requiring not least efficient shielding.

Consequently, the signal switch devices conventionally used within the RF communications field, and specifically in high power RF applications, are not satisfactory and there is a considerable need for developments solving the presented problems related to the provision of reliable RF-signal switching at reduced cost and with a low space requirement.

### SUMMARY

It is a general object of the invention to enable space efficient and cost effective switching of multiple radio frequency signals in electronic appliances.

In particular, it is an object of the invention to provide an improved device for coupling multiple radio signals in different directions in radio units, said device having low space requirement and low production cost.

This and other objects are met by the invention as defined in the accompanying patent claims.

To achieve the above stated objects, the invention provides an effective, compact and reliable device for switching high power RF signals in a radio unit. Briefly, the invention provides a switch device comprising an RF matched card holder for mounting on a printed circuit board and having signal contact elements supported therein and an RF matched switch card to be received in alternative positions in the holder and having multiple sets of contact pads on at least one side thereof and signal paths extended between selected contact pads of each set.

In an embodiment of the invention sets of contact pads on the switch card are provided on upper and lower sides, respectively, of the card.

By providing a different pattern of signal paths on each side of the card the device will be set in different operating modes depending upon the positioning of the card in the holder.

Preferred further developments of the basic inventive idea as well as embodiments thereof are specified in the dependent subclaims.

Advantages offered by the present invention, in addition to those described above, will be readily appreciated upon reading the below detailed description of embodiments of the invention.

### BRIEF DESCRIPTION OF THE DRAWINGS

The invention, together with further objects and advantages thereof, will be best understood by reference to the following description taken together with the accompanying drawings, in which:

FIG. 1 is a schematical view of a prior art relay type switch configuration having two alternative switching modes;

FIG. 2A is a schematical view of an exemplary embodiment of a switch configuration of the invention, likewise having two alternative switching modes, in a first switching mode;

FIG. 2B is a schematical view of the exemplary embodiment of the switch configuration of the invention, in a second switching mode;

FIG. 3 is a top perspective view of an exemplary embodiment of a switch card device of the invention; and

FIG. 4 is a partial, schematical longitudinal section through the exemplary switch card device of FIG. 3;

FIG. 5A is a very schematical illustration of a first side layout of an exemplary switch card for use in a switch device of the invention; and

FIG. 5B is a very schematical illustration of a second side layout of the exemplary switch card of FIG. 5A.

### ABBREVIATIONS

PCB—Printed circuit board

DRU—Radio Unit

RF—Radio Frequency

### DETAILED DESCRIPTION

Throughout this specification reference is made to RF switch applications intended for radio units for transmitting and receiving radio signals and specifically to high power RF signal applications. It shall be emphasized, though that such reference is made for the purpose of describing exemplary applications and preferred embodiments of the invention and is not intended to limit the invention to any specific radio communication application or to any particular power range or specifically to the details of such applications.

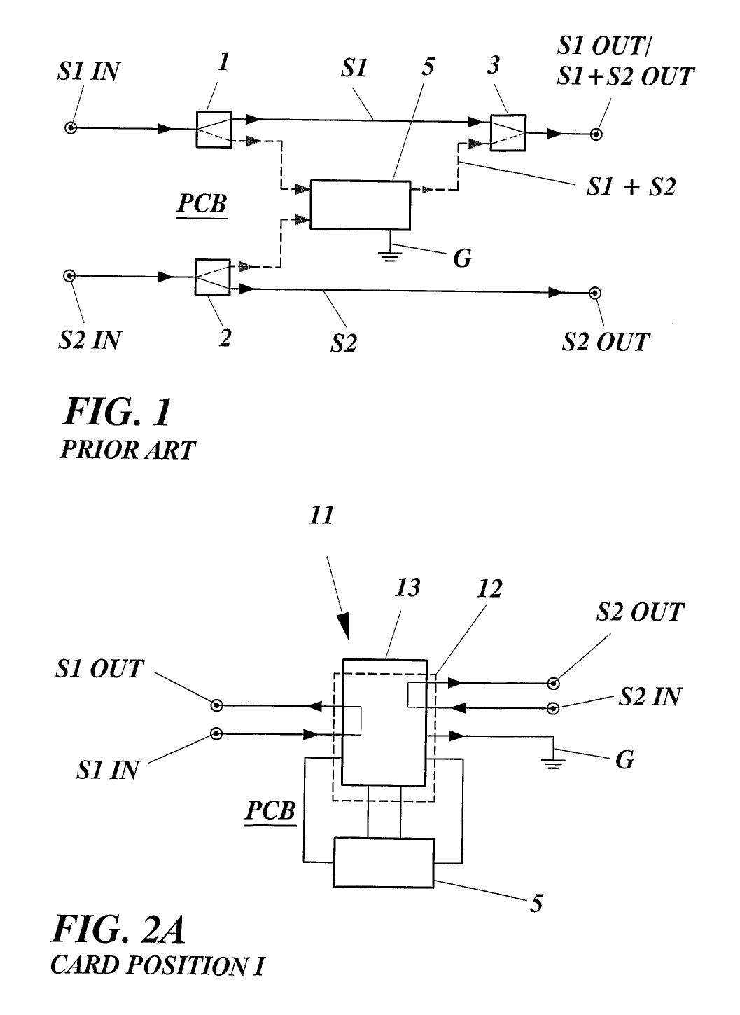

In existing radio units functioning for the transmission and reception of radio signals and for use in i.e. the field of telecommunications, it has been common to use a number of relay switches with control signals from software, in situations where radio signals should be coupled in different directions. In FIG. 1 is illustrated a typical such prior switch configuration used for switching high power RF signals in a radio unit used within the telecommunications field. In this switch configuration three relay switches 1-3 with electronic switch remote are connected to a PCB of the radio unit (not specifically illustrated). The illustrated, typical switch configuration generally concerns a transmitting and receiving radio unit requiring a switching configuration with a two mode switch function. In a first mode two separate RF signals S1 and S2, respectively, are transferred from the respective inputs S1 IN and S2 IN, through the respective relay switches 1, 3 and 2, to the respective outputs S1 OUT and S2 OUT. In a second mode the RF signals S1 and S2 are combined in a combiner or mixer 5 and the combined signal S1+S2 is transferred to a common output S1+S2 OUT, through the relay switch 3 that in the first mode transfers the first signal S1 to its output S1 OUT.

With such a conventional solution, a comparatively large PCB area is occupied by the relay switch components 1-3 and the component cost is high. The relay concept is based on the principle of connecting signals by pulling contact surfaces of the relay switches into engagement with each other by means of a solenoid. This concept can involve a serious risk of malfunction, especially after many years of use. There is also considerable power consumption in each of the relays 1-3. As mentioned, quality problems have been an issue for these relays, resulting in a high time consumption and added cost. This, in addition to the questionable long term functionality and comparatively high power consumption, makes such a relay based switch configuration less attractive.

It is a general fact that in the development of DRU units attempts have been made in the past to try and reduce space and cost. There are many ways of reducing cost, such as by designing components that are less expensive to produce, reducing PCB area, designing modules, simplifying designs, removing features and/or functions, reducing weight etc. In accordance with the solution presented by the invention, most, if not all of these desired, advantageous improvements are achieved. Basically, the reduction of the space requirement achieved by means of the solution according to the present invention, could in future DRU projects even make it possible, together with other modifications, to reduce the size of the entire PCB.

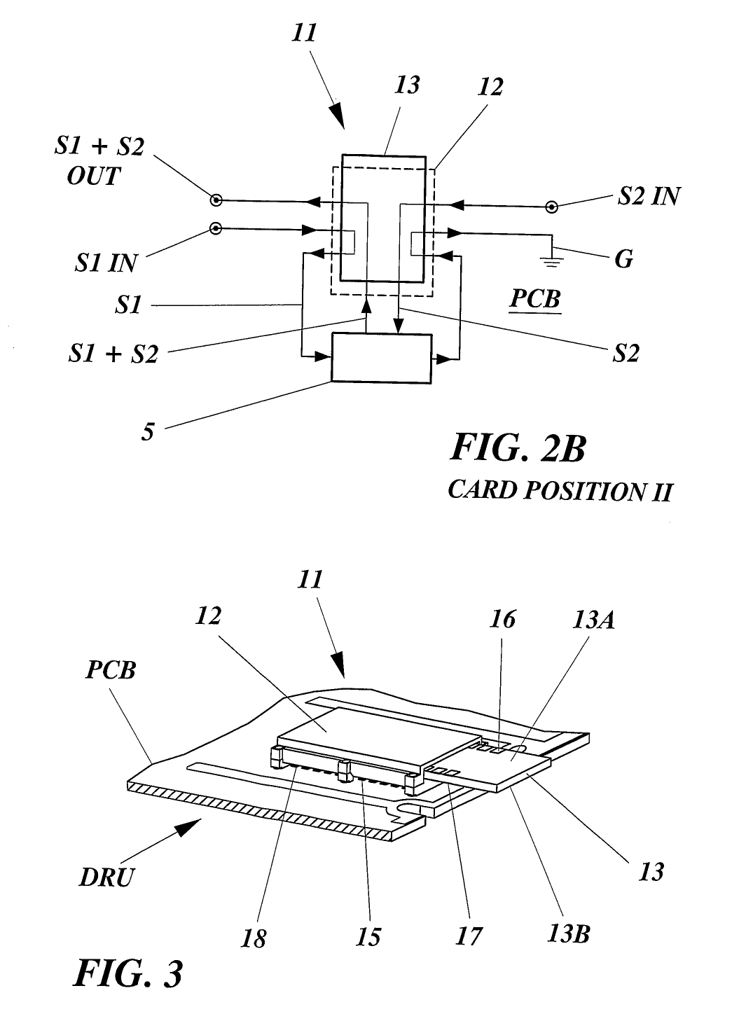

The invention will be explained below with reference to exemplifying embodiments thereof that are illustrated in the accompanying drawing FIGS. 2A-B, 3-4 and 5A-B. In said drawing figures are disclosed very schematical embodiments of the inventive switch configuration. Like the typical prior relay switch type configuration of FIG. 1, the illustrated embodiments of the invention are all directed to a switching configuration with a two mode switch function. It shall be emphasized, though, that the invention shall not be restricted to such a two mode function. Instead, the invention may likewise be used for other types of switching configurations where additional signals are to be transferred, in turn requiring additional mode functions. Generally, as will become clear from the following description, the invention therefore, within practical limits, covers embodiments for the switching of multiple RF signals in an optional number of modes, as required for different applications.

In FIGS. 2A-B is very schematically disclosed a first exemplary embodiment of an inventive switch configuration that may be applied for switching high power RF signals in a radio unit DRU. Generally, this particular embodiment is intended for use with high power RF signals of approximately 1 W and higher. However, it shall be emphasized that the invention is not restricted to such a specification of the high power range. As discussed above, it will in the illustrated embodiment likewise be used for transferring two separate RF signals S1 and S2 from respective inputs S1 IN and S2 IN to respective outputs S1 OUT and S2 OUT in one mode; and to combine the RF signals S1 and S2 and transfer the combined signal S1+S2 to a common output S1+S2 OUT in a second mode. With specific reference to FIGS. 2A-B the invention provides a switch configuration, comprising a signal switch device or module 11. In sharp contrast to the prior relay type switch configuration, said switch device 11 consists of an RF matched card holder 12 that is intended for mounting on and connection to a very generally denoted PCB of a radio unit (not specifically referenced). The device 11 further includes an RF matched switch card 13 that is adapted to be received in the card holder 12. The invention is based on the concept of having a switch card 13 that is provided with different signal contact layouts on different parts of the card and that is adapted to be received in alternative positions in the card holder 12. Thereby, the card holder 12 and card 13 combination will provide the desired two mode functions depending upon the chosen position of the card 13 in the holder 12.

In the embodiment of FIGS. 2A-B two RF signal inputs S1 and S2 are separately connected from the PCB to the card holder 12 that is also connected to ground G. Signal outputs S1 OUT, S2 OUT are likewise connected from the card holder 12 to the PCB. Finally, a combiner 5 on the PCB is connected to the card holder 12. Specifically, the first switch mode card position I is illustrated in FIG. 2A. In said first card position I, the signal inputs S1 IN and S2 IN are separately routed by the switch card 13 to the signal outputs S1 OUT and S2 OUT on the PCB and no signal is routed through the combiner 5.

For the second mode function, the switch card 13 is inserted into the card holder 12 in the second switch mode card position II that is illustrated in FIG. 2B. In said second card position II, signals S1 and S2 are separately routed by the switch card 13 from the signal inputs S1 IN and S2 IN to separate signal connections (not specifically denoted) on the combiner 5, from which a combined signal S1+S2 is connected back to the card 13. This combined signal S1+S2 is then routed by the card 13 to a combined signal output S1+S2 OUT on the PCB. For this combined signal output S1+S2 OUT may be used a separate connection or one of the separate signal output connections.

The invention, as described, provides a significant cost reduction when used in applications where radio signals are to be coupled in different directions, like in a contact switch. In fact, the holder and two-mode card combination of the invention may in DRU applications lower the price with more than 90% compared to the prior relay type switch configuration. Another essential benefit of this configuration is that in situations where only two status modes are present in an application, it is possible to integrate multiple switch functions in one component providing two basic modes. Additionally, the proposed switch device using only one component, namely the two position/two mode switch card, instead of three or maybe more relays depending upon the application, provides a considerable material and/or weight reduction. Other benefits of the inventive switch device are: reduced power consumption, less quality problems, saving of PCB area, lower component cost, easier handling in logistics and an unshielded simple design. The robust and manual handling of the switch function can also improve the yield of products.

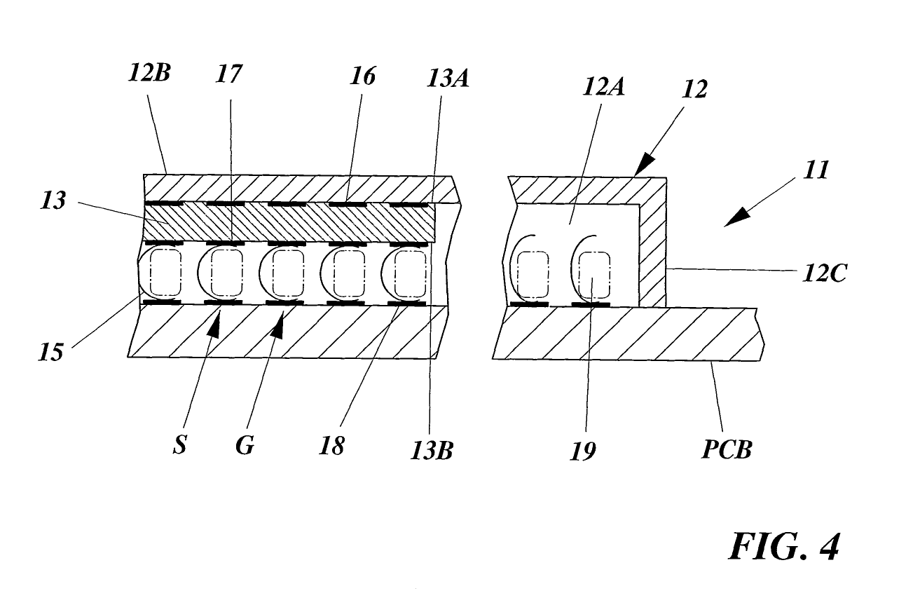

A practical embodiment of the switch device 11 according to the invention will now be described with reference to FIGS. 3-4 and 5A-B. In FIG. 3, the card holder 12 is illustrated as surface mounted to a partially illustrated PCB of a radio unit DRU used for transmitting and receiving RF signals. The card holder part 12 is preferably made of suitable high temperature plastic. The epsilon value (dielectric constant) of the used medium is of importance for the function, since it affects the RF performance. Multiple signal coupling contact elements in the form of contact springs 15 are floatingly supported on structural parts 19 of the card holder 12. The contact elements 15 are provided for contacting contact pads 18 on the DRU circuit board PCB in use, and for establishing a signal connection between said PCB contact pads 18 and later described contact pads 16, 17 of the switch card 13. In the exemplifying embodiment the card holder 12 has twenty contact springs 15, ten on each side, to offer the accurate contact force. Said contact springs 15 are shown as floatingly supported within a card receiving space or pocket 12A delimited generally by an upper wall 12B and an end wall 12C. Between each signal contact S there is a ground contact G to achieve the correct signal performance.

In the practical embodiment of the inventive device or module 11 that is illustrated in FIGS. 3, 4 and 5A-B, a two sided switch card 13, having a first side 13A (upper flat side in FIG. 3) and an opposite second side 13B (lower flat side in FIG. 3), is used with the card holder 12. In this exemplary embodiment the card 13 has a different contact pattern or layout on each side 13A, 13B, which set the switch card 13 in different operating modes depending upon the position of the switch card in the holder 12. Specifically, two sets of contact pads 16, 17 are provided, with one set on each of the first and second sides 13A and 13B, respectively, of the switch card 13. Signal paths SP are extended between selected contact pads 16, 17 of each set to establish the two different modes for the switch functions performed by the device.

Each side 13A, 13B of the switch card 13 is preferably provided with means being indicative of the functional position of the switch card 13 in the card holder 12. The functional position entered by the card 13 when inserted into the holder 12 is dependent upon how it is turned, or in other words, which of its first and second sides 13A and 13B, respectively, that faces downwardly, contacting the coupling contact elements 15. The position indicating means may consist of contact pads PI OUT in each set of contact pads 16 and 17, respectively, on the switch card 13, for coupling a signal to the printed circuit board PCB of the DRU confirming that the switch card 13 has been correctly inserted in the selected position in the card holder 12. Likewise, each side 13A, 13B of the switch card 13 is preferably provided with means being indicative of the status of the switch card 13 with regard to its complete insertion into the card holder 12. Said status indicating means may likewise consist of contact pads SS OUT in each set of contact pads 16 17, respectively, on the switch card 13 for coupling a signal to the printed circuit board PCB of the DRU confirming that the switch card 13 has been fully inserted in the card holder 12.

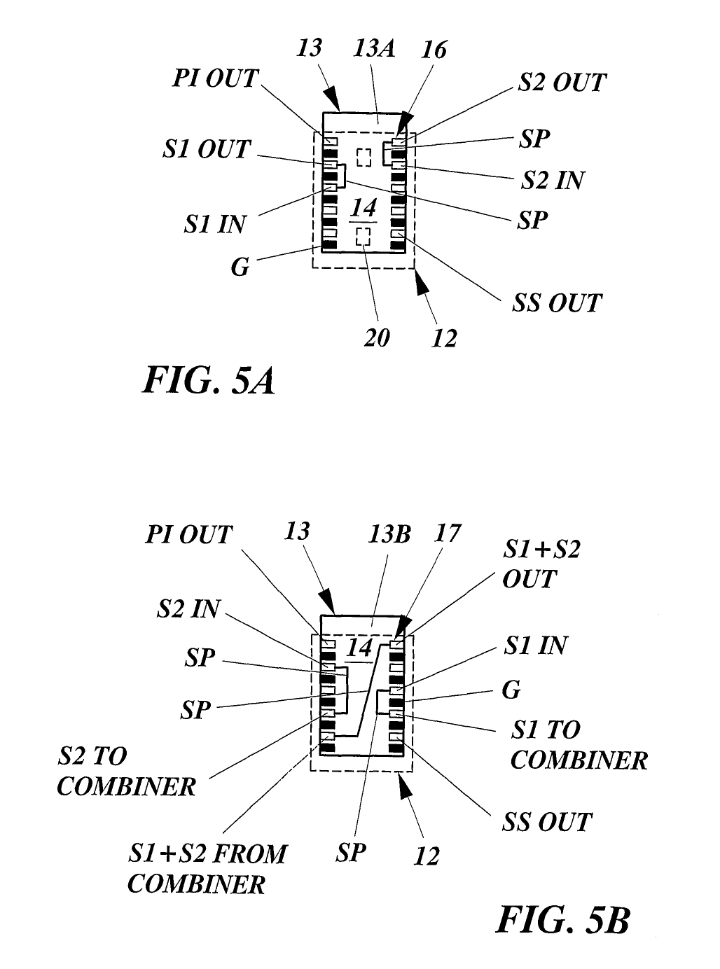

It will now be realized that a switch card 13 having two different layouts on its different first and second sides 13A, 13B, like in the embodiment of FIGS. 5A-5B, makes it possible to employ the disclosed holder and card module 11 in configurations for performing two mode switch functions, as discussed with reference to FIGS. 2A-B. Accordingly, when the card 13 of FIGS. 5A-B is introduced into the card receiving space 12A of the holder with its first side 13A, having the set of contact pads 16 (FIG. 5A), facing the contact elements 15, this corresponds to the card position I of FIG. 2A. In particular it will be seen that the signal paths SP of the layout of said first card side 13A route the signal inputs S1 IN and S2 IN directly to the respective signal outputs S1 OUT and S2 OUT. Likewise, when the card 13 of FIGS. 5A-B is introduced into the card receiving space 12A of the holder with its second side 13B, having the set of contact pads 17 (FIG. 5B), facing the contact elements 15, this corresponds to the card position II of FIG. 2B. In particular it will be seen that the signal paths SP of the layout of said second card side 13B route the signal inputs S1 IN and S2 IN to the combiner and then route the combined signal output S1+S2 from the combiner to the assigned signal output S1+S2 OUT.

A possible further development of the inventive card 13 is also indicated in FIGS. 5A-B, according to which the switch card 13 may in itself be made up of or may alternatively include a switch board 14 in a form of a printed circuit board. Such a card may be made of standard PCB material but shall be matched for the specific application wherein it will be used. Using such a PCB type switch card 13 or switch board 14 it will also be possible to integrate one or several chip components 20 (see FIG. 5A) on the switch card 13 to assign further functions to the device 11.

Although the invention has been described and illustrated with specific reference to practical embodiments thereof as well as to an exemplary application thereof in a radio unit, the invention is in no way restricted to such embodiments or to such applications. The basic principles of the invention may therefore, in the widest scope of the invention, be applied to any type of present or future electronic appliance requiring switching of RF signals.

In alternative, but not specifically illustrated embodiments of the invention variations of the switch configuration may be employed without departing from the scope of the invention. One example thereof is the theoretically possible variation of having two different layouts or patterns on one and the same side of the card, positioned in an area close to the respective short ends of the card. In other words, to change the position of such a card it would not be turned upside down but would instead be rotated around an axis being perpendicular to the upper and lower flat sides thereof. It would even be possible, in a further variation, to provide a four mode switching configuration by having two such card end area layouts on each of the first and second flat sides thereof.

The invention likewise covers other configurations including modified designs of the different illustrated parts of the device, intended for other applications. Among such modifications that are covered by the invention are; the shape and number of the holder contact elements, the actual card holder structure, the size of the card and card holder, the number of connections etc.

Although the invention has been described and illustrated herein in connection with what is presently considered the most practical and preferred embodiments and applications thereof, it should be understood that the invention is in no way restricted to such disclosed embodiments and applications. The invention is therefore intended to cover various modifications and equivalent arrangements included within the appended claims.

1-6. (canceled)

7. A device for switching high power RF signals in a radio unit, said device comprising:
an RF matched card holder for mounting on a printed circuit board of the radio unit;
multiple signal coupling contact elements supported in the card holder;
an RF matched switch card configured to be received in alternative positions in the card holder,
multiple sets of contact pads on at least one side of the switch card; and
signal paths extended between selected contact pads of each set;
wherein the multiple sets of contact pads include at least one of:
contact pads for coupling to the printed circuit board of the radio unit a signal indicative of the position of the switch card in the holder; and
contact pads for coupling to the printed circuit board of the radio unit a signal indicative of the status of the switch card, with regard to its complete insertion into the card holder.

8. The device of claim 7, wherein the multiple sets of contact pads include one set of contact pads of the switch card on each one of a first and a second side of the switch card.

9. The device of claim 8, wherein the switch card has a different pattern of signal paths on each side thereof, which sets the switch card in different operating modes depending upon the position of the switch card in the holder.

10. The device of claim 7, wherein the switch card is or includes a switch board in a form of a printed circuit board.

11. The device of claim 10, the switch card or switch board includes integrated chip components.

12. The device according of claim 7, wherein the signal coupling contact elements are contact springs that are floatingly supported on structural parts of the card holder for contacting contact pads on the unit circuit board and contact pads of the switch card in use.

13. A device for switching high power RF signals in a radio unit, said device comprising:
an RF matched card holder for mounting on a printed circuit board of the radio unit;
an RF matched switch card configured to be received in alternative positions in the card holder by virtue of having:
a first set of contact pads on a first side of the switch card and a second set of contact pads on a second side of the switch card;
said first and second sets of contact pads having different patterns of signal paths such that the device will be set in different operating modes in dependence upon the positioning of the switch card within the card holder.
